(19) United States
(12) Patent Application Publication
(10) Pub. No.: US 2007/0115299 A1
(43) Pub. Date: May 24, 2007

(54) System and method for creation of motor vehicle graphics

(76) Inventors: Brett Barney, West Jordan, UT (US); Landon Boone Allred, West Jordan, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/336,320

(22) Filed: Jan. 20, 2006

Related U.S. Application Data
(60) Provisional application No. 60/739,514, filed on Nov. 23, 2005.

(51) Int. Cl. G09G 5/00

(52) U.S. Cl. 345/619

(57) ABSTRACT

The present invention relates to methods, apparatus, product by-process, and computer program product for generating graphics for motor vehicles such as motorcycles, four-wheelers, snowmobiles, bullet bikes, auto vehicles, and the like. A user interface is provided which supplies the tools for allowing a user to create desired graphics. The user interface can comprise a software program, an Internet website, a kiosk, or an end-user type system, which allows a user to generate customized graphics at the user's selection and discretion. The graphics are positioned on a decal, sticker, mask, or similar medium for placement on the motor vehicle. The graphics, once created, can also be relayed to an automated system which directly applies the graphics to the motor vehicles.

### CROSS-REFERENCE TO RELATED APPLICATIONS

This application claims the benefit of U.S. Provisional Application No. 60/739,514, filed Nov. 23, 2005, and entitiled, “System and Method for Creation of Motor Vehicle Graphics, which is incorporated herein by this reference.”

### BACKGROUND OF THE INVENTION

1. The Field of the Invention

The present invention relates to systems and methods for generating graphics images. In more particular, the present invention relates to systems and methods for allowing a client to create customized graphics for placement on a motor vehicle, such as a motorcycle, ATV, or snowmobile.

2. The Relevant Technology

In recent years, customized graphics for motor vehicles, such as motorcycles, ATVs, snowmobiles, and automobiles, have gained increasing popularity. Owners of such motor vehicles will typically commission skilled designers and/or airbrush artists to conceptualize and paint desired designs on different portions of a motor vehicle. For example, graphics designs are heavily utilized on customized vehicles, such as chopper motorcycles, hot-rod automobiles, or customized snowmobiles. Such graphics images have also been utilized with stock motor vehicles to add a sense of individuality to otherwise standard models.

Typically, the cost for designing and painting such designs on these motor vehicles can be quite expensive. As a result, many motor vehicle owners who cannot afford customized design have opted to attempt to create their own designs. However, self-made designs typically do not satisfy the aesthetics requirements desired by such consumers. Alternatively, some owners have opted to purchase decals, which can be placed on the particular motor vehicle. A number of companies have designed decals to provide the type of stylized images desired by many motor vehicle owners.

One difficulty associated with the creation and purchase of decals for motor vehicles, is the fact that such decals are often designed to be positioned on particular components of a motor vehicle. The size and shape of the components of the motor vehicle can widely vary in shape and size from one model of motor vehicle to another. For example, a Honda® BMX-style motorcycle may have a much different gas tank design than a Yamaha® BMX-style motorcycle. Additionally, different models of a particular motor vehicle may vary widely even for a given maker of such motor vehicles. For example, one Yamaha® ATV may have much different size and design requirements than another Yamaha® ATV.

As a result of the large variability in the number of different makes, models, and years of motor vehicles, typically decal manufacturers are limited to providing a very small selection of decals for a given make or model of motor vehicle. For example, an illustrative motorcycle such as a hypothetical 2000 Horsley Trail Rider may have only three or four different decal packages that can be purchased by a user. However, due to the fact that decals are typically utilized by users to add customization to their motor vehicle, the limited selection of designs available provides little in the way of customization desired by such motor vehicle owners. In other words, the limited selection of designs provided for each model of motor vehicle largely defeats the purpose of utilizing such decals on the motor vehicle.

### BRIEF SUMMARY OF THE INVENTION

The present invention relates to methods, apparatus, systems, product-by-process, and computer program products for generating graphics for motor vehicles. Such motor vehicles can include motorcycles, four-wheelers, snowmobiles, bullet bikes, auto vehicles, and the like. In one embodiment, a graphics application resident either upon, on a local client, and/or upon a remote server which is accessible by a local client. The graphics software application facilitates selection and optionally customization of graphics for motor vehicle decals, stickers, or similar medium for placement on the motor vehicle. Optionally, the graphics, once created, can be relayed to an automated system which directly applies the graphics to the motor vehicles.

According to one embodiment of the present invention, a user interface supplies the tools for allowing a user to create desired graphics. The user interface can include a software program, an Internet website, a kiosk, or an end-user type system, which allows a user to generate customized graphics in accordance with the user's selection.

According to another embodiment of the present invention, a system accessible via a user interface provides a database containing selectable graphics components which can be combined, manipulated, modified, or selected as desired by the user to create customizable graphics for the user's motor vehicle. According to one embodiment of the present invention, such graphics components can include background, images to be placed on background, text, stock graphics and other known graphics, designs, or user selectable images. For example, a user can select from a variety of potential background templates which can be utilized as the background for the graphics image. The user can then select an image, or images, to be placed on the background to create a desired effect. The user can then select text to be placed as desired on the background and/or image to create an overall graphic design. For example, according to one embodiment of the present invention, the background can comprise elements of a flag, such as the American flag. A user can then interpose an image on the American flag in a position and placement as desired by the user. For example, an illustrative image can include the likeness of Uncle Sam or an American soldier. The user can then select text as desired by the user, such as the phrase “I'm proud to be an American.” Once the text is selected, the text can be positioned on the American Flag. Additionally, the text can be modified such as by selecting from a number of different desired fonts, colors, or sizes. Optionally, the system can include tools to enable a user to import an electronic file containing an object or variant supplied by the user to be placed within the graphics field as background, an overlying image, font, logo, or the like.

According to another embodiment of the present invention, the system, methods, and/or client interface provides the user with customer selectable manipulation of the components of the graphics. For example, the user can scale, rotate, move, add text, change the color scheme, change the color of individual components of the graphics, change text, and/or change the juxtaposition of the size of the elements. For example, the user may select the desired background and then rotate the background through the user interface to create a different effect and impression of the background. The user may then increase or decrease the scale of the background to again change the impression of the image. The user may then select an image to be placed upon the background. The image can be moved and the color scheme of the image can be altered as desired by the user.

The user can then add text to the overall graphics image. The text can then be scaled to increase or decrease the size of the text. Additionally, the text can be moved to a different portion of the graphic. The user may then desire to change the text color, or other font characteristics of the text. The user may continue to change the juxtaposition size or other characteristic of the background image or text of the image. This example is provided solely as an illustrative example of some of the capabilities that can be provided by the system and accessible on the user interface for selectable manipulation and alteration of the graphic to be created.

In one configuration, the user is allowed to provide the type of motor vehicle, the model, year, style, or other characteristic of the motor vehicle to the system through the user interface. The system can then select, based on the biographic information of the vehicle, the final shape of the graphics. The final shape of the graphics can include a cut path for a decal which is to be placed on a particular part or position of the motor vehicle. As the user is manipulating and altering aspects of the graphics, the cut path, or final shape of the graphics, can be shown on the user interface allowing the user to visualize the potential final shape of the graphic relative to the ornamental aspects of the decal or graphic.

Individual components of the motor vehicle can have customized decals created for some or all of the components of the motor vehicle. For example, according to one embodiment of the present invention, a motorcycle can have separate graphics created for the tank, shroud, front fender, rear fender, front number plate, side number plate, air box, swing arm, and fork guards, and the like. According to another embodiment of the present invention, a snowmobile is selected and decals or graphics can be created for the hood, belly pan, and tunnel of the snowmobile. According to yet another embodiment of the present invention, a four-wheeler can be selected and individual graphics can be created for front and rear fenders, tank, and the skid plate. According to yet another embodiment of the present invention, one or more individual graphics can be created for another motor vehicle such as a auto vehicle, scooter, or the like.

Optionally, individual graphics can be created by the user for each and every component of the motor vehicle so as to create an overall impression for the motor vehicle. Such individual graphics can be customized by the user to a high degree of detail and specificity. Once the layout has been selected for each of the components of the motor vehicle, a rendering of the graphics on the vehicle can be displayed to the user through the user interface of the system to allow the user to visualize the overall design and graphic impression of the combined graphics components for each and every component of the motor vehicle. For instance, a side view, front view, rear view, and alternate side views for each motor vehicle can be created. Alternatively, a substantially 3-D-type image of the motor vehicle can be provided allowing the user to rotate the image to view different angles of the graphics on the motor vehicle.

Once the user has finalized the selection and design of the graphics, the system can propagate an image to a file, memory, or other destination. The image file or files can then be associated with a customer order number, or other identifying information allowing for quick and easy identification of the selected graphic for payment, storage, or other commercial purposes. Once the user has placed the order, the files or files can then be sent to a generation module in which the file is utilized to generate an image, either on a vehicle, or decal to be placed on the vehicle, or other appropriate medium. The image can also be manipulated as necessary to provide for optimized design of the graphic relative to the interface for generating the graphic for placement on the motor vehicle. For example, the image can be rescaled as necessary to fit the decal, or component of the motor vehicle. Additionally, according to one embodiment of the present invention, the customer can select that no further manipulation or alteration of the graphic be implemented. Additionally, the user can select that the graphic fit a customized component by giving the cut path, dimensions, curvature, or other information related to the customized component for the motor vehicle.

The user interface that provides access to the system to provide a number of different screens, interface buttons, tools, or the like to allow for a simple and effective browsing of the interface, such as a website, to create the desired graphics. Additionally, the user interface can enable the user to select and require customer information, billing information, age identification, confirmation, and electronic commerce populated pages, fields, and the like.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of a client interface providing tools for creation of graphics images, according to one embodiment of the present invention.

FIG. 2 illustrates a network environment in which the client interface can be utilized to allow clients to remotely create graphics images which can be prepared for disposition on a motor vehicle.

FIG. 3 is flow diagram illustrating steps allowing a user to create a graphics image utilizing the client interface.

FIG. 4 is an exemplary view of backgrounds that can be utilized in creation of the graphics image, according to one embodiment of the present invention.

FIG. 5 illustrates graphics images that can be utilized either alone or with a background to create a graphics image, according to one embodiment of the present invention.

FIG. 6 illustrates selection fields providing variables that are utilized in the creation of graphics images for different components of a motor vehicle in connection with the client interface, according to one embodiment of the present invention.

FIG. 7 is a depiction of the client interface, illustrating the layout of a graphic rendering.

FIG. 8 is a logic diagram illustrating variables and selection processes that can be utilized in modifying different components of the graphics, according to one embodiment of the present invention.

FIG. 9 is an illustrative operating environment in which the client interface, software, computer readable medium, or other systems for creating a graphic interface can be utilized according to one embodiment of the present invention.

### DETAILED DESCRIPTION OF THE PREFERRED EMBODIMENTS

The present invention relates to systems, methods, computer program product, for the creation of a graphics image for disposition on a motor vehicle, according to one embodiment of the present invention. The graphics image can be created by a user utilizing the client interface, a computer program product, methods, and apparatus for disposition on a motor vehicle on a provider side application, such as a paint system, decal creation system, magnetic decal, or the like.

According to one embodiment of the present invention, a graphic interface is provided having the tools for the creation of a graphic image. For example, a user can select a given motor vehicle type, the year, make, and model of the motor vehicle, and in return is provided with selection of different locations on the motor vehicle on which a graphics image can be positioned. The user can then select from a variety of different graphics components to create a finalized graphics image. For example, a user can select from a gamut of different potential background images as the background to be used with the graphic. The user can then select from a variety of different images or image components to be placed on the background of the image. The user can then scale, rotate, move, change the color scheme, alter individual components, add text to, or otherwise modify one or more components of the graphic image to change the overall look and impression of the graphic.

Once the user is satisfied with the design of the graphic, the user can select to have the look and fill of the graphic propagated to other graphic locations on the motor vehicle. The user can then accept, modify, or recreate the graphics for other locations on the motor vehicle to change the look and feel of the complete image of the motor vehicle as created by the combination of the different graphics images as created by the user. The user can then select to have a set of decals created corresponding with the graphic images, such that they can be placed on the desired positions on the motor vehicle. Additionally, the user can select that the graphic be directly placed on the motor vehicle utilizing an automated or other disposition technique utilizing the graphic created on the client interface. The client interface can also include e-commerce technology for purchase of the graphic image subsequent to creation of the image on the client interface.

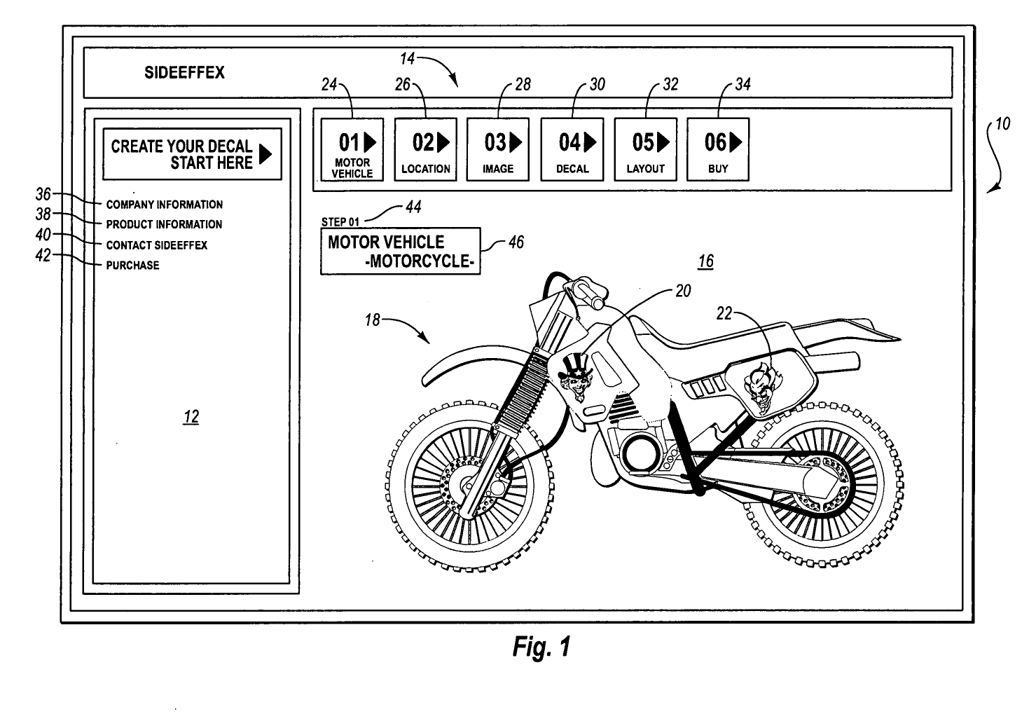

FIG. 1 is a perspective view of a client interface 10, according to one embodiment of the present invention. Client interface 10 provides the tools to allow a user to create a customized graphic image or graphic image package to be placed on one or more locations of a motor vehicle to create a customized look and feel to the motor vehicle. According to the illustrated embodiment of the present invention, client interface 10 comprises a new client navigation section 12, a graphics creation tool bar 14, and a graphic interface 16. New client navigation section 12 provides a variety of information links which allow a new client or other user to ascertain information relevant to the graphics creation system including information about the provider company, purchase information, and the like. The graphic creation tool bar 14 provides tools facilitating creation of the graphics image by the user utilizing the client interface 10. Graphics interface 16 provides an interface tool which illustrates images, graphics, and selections during the course of the graphics creation process. Graphics interface 16 allows the user to visualize the graphic creation process facilitating creation of the graphic as desired by the user.

In the illustrated embodiment, graphic interface 16 illustrates a motorcycle 18 positioned thereon. Motorcycle 18 represents one type of motor vehicle that can be selected by the user to create a set of graphics images for disposition on a motorcycle. In the illustrated embodiment, motorcycle 18 includes a gas tank graphic 20 and an exhaust plate graphic 22. Gas tank graphic 20 and exhaust plate graphic 22 provide illustrative examples of the type of graphics that can be included on a motor vehicle to create a customized and unique impression on the motorcycle 18. The illustration of motorcycle 18 also facilitates the type of imagery and comprehension of the functionality that can be provided utilizing client interface 10. For example, as a user navigates client interface 10, the illustration of motorcycle 18 on the graphic interface 16 suggests to the user that client interface 10 can be utilized to create graphics which can be readily positioned on different components of a motorcycle to create a unique and customized impression on the motorcycle. The user can also select different motor vehicle types to visual the types of graphics that can be created for different motor vehicle types. By being able to select different motor vehicle types, the user can change the look and impression of alternative types of motor vehicles.

Graphic creation tool bar 14 comprises a vehicle selection thumbnail 24, a graphic location selection thumbnail 26, an image selection thumbnail 28, a cut-path configuration thumbnail 30, a layout thumbnail 32, and a graphic purchase thumbnail 34. Thumbnails 24, 26, 28, 30, 32, and 34 facilitate the graphic creation process on a step-by-step basis. For example, vehicle selection thumbnail 24 represents a first step in a graphics creation process. Vehicle selection thumbnail 24 allows a user to select a type of motor vehicle, including year, make, and model of the motor vehicle. This allows the user to select and identify the type of motor vehicle on which the graphic will be positioned. In the illustrated embodiment, graphic interface 16 illustrates that a user is utilizing the vehicle selection thumbnail 24 step of the process. Graphic selection thumbnail 26 allows the user to select the location or portion of the vehicle on which the graphic is to be positioned. This permits the user to create a unique graphic image for each and every different location on which a graphic image can be positioned on the motor vehicle.

Image selection thumbnail 28 allows the user to select images that can be utilized to create the overall look and feel of the image during the graphic creation process. Cut-path configuration thumbnail 30 allows the user to view the image which corresponds with the particular cut-path for different components of the motor vehicle. For example, the cut-path for a gas tank graphic can vary greatly from the cut-path of the front forks of a motorcycle. Cut-path configuration thumbnail 30 allows for the customization and modification of the graphic to fit the desired cut-path of the particular component.

Layout thumbnail 32 illustrates to the user the particular look and feel of the layout of the graphic relative to the cut-path. Additionally, layout 32 allows the user to manipulate, modify, or otherwise change components of the layout to change the overall look and impression of the graphic on that particular cut-path. Graphic purchase thumbnail 34 allows the user to input purchase and payment information to purchase the graphics package to be provided by the provider such that the graphic can be positioned, deposited, or otherwise placed on the motor vehicle.

New client navigation section 12 comprises a company information link 36, a product information link 38, a contact link 40, and a purchase information link 42. When a client is navigating the client interface 10, the client can access information relevant to the provider, the overall creation process, purchase information and the like. By navigating links 36, 38, 40, and 42 a user can understand both the graphic creation process as well as information regarding the company from which they are purchasing the graphics images. Company information link 36 contains information relative to the provider company, such as newsworthy articles, background information, executive managerial team, and the like. Product information link 38 contains information relevant to the product that can be purchased by the user. For example, different motor vehicles having graphics created utilizing the client interface can be illustrated. Additionally, alternatives for disposition of the graphics on a motor vehicle can be explained and/or depicted. Additionally, appropriate disclaimers, legal information, and the like can be contained in the product information link 38. Contact link 40 provides contact information relevant to the provider and/or suppliers associated with the provider. Purchase information link 42 can provide the user with purchase contract information, user agreements, disclaimers, and the like associated with the purchase and e-commerce capabilities of the client interface 10.

In the illustrated embodiment, graphic interface 16 further comprises a graphic creation step indicator 44 and a client selection indicator 46. Graphic creation step indicator 44 illustrates to the user which of the different steps of the graphic creation process the client is currently undertaking. For example, in the illustrated embodiment, graphic creation step indicator 44 depicts that step 01, which corresponds with vehicle selection thumbnail 24, is currently being undertaken. Client selection indicator 46 provides information which facilitates the graphic creation process. For example, in the illustrated embodiment, client selection indicator 46 illustrates the motor vehicle which has been selected is a motorcycle. Client selection indicator 46 can also be populated with selections that can be chosen by the user during the graphics creation process. For example, client selection indicator 46 can indicate or contain thumbnails for year, make, and model of different types of motorcycles that can be selected by the user to more closely tailor the type of motor vehicle on which the graphics images are to be positioned.

As will be appreciated by those skilled in the art, a variety of types and configurations of client interfaces can be provided without departing from the scope and spirit of the present invention. For example, the client interface 10 can comprise an Internet webpage that can be accessed by the user to create a graphics image. According to another embodiment of the present invention, the client interface can comprise a peer-to-peer tool which allows for the creation of a graphics image. According to another embodiment of the present invention, the client interface can comprise software which can be loaded by the user to create a graphics images. The graphics image can then be subsequently communicated with a provider network to render the particular graphic. According to another embodiment of the present invention, the client interface can be provided as hardware or software on a kiosk at a desired location, such as a mall, motor vehicle vender, sporting event, or retail vendor show. According to another embodiment of the present invention, the client interface facilitates creation of the image utilizing a dynamic process, rather than a step-by-step process.

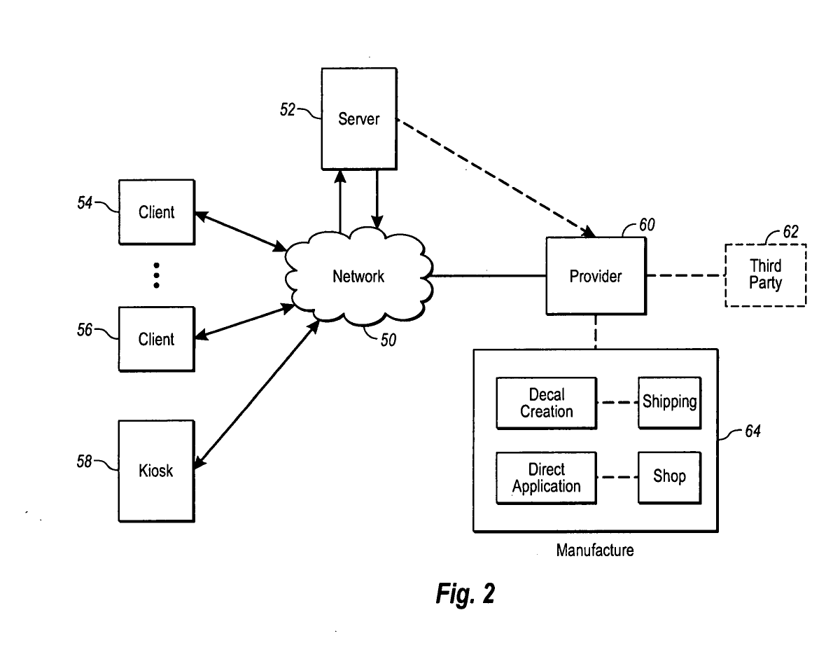

FIG. 2 is an illustrative embodiment of a network system that can be utilized to provide a client interface, according to one embodiment of the present invention. In the illustrated embodiment, a network 50 is provided. Client 54, client 56, and a kiosk 58 are operably connected to network 50. Network 50 is connected to a server 52, which provides system communication to populate and provide functionality associated with a client interface. A provider system 60 is also operably connected with network 50 and optionally with server 52. Provider system 60 can upload data relative to the client interface and download customer orders that have been created and the corresponding graphics images that have been purchased by client utilizing the system.

Provider system 60 is optionally connected with a manufacture/graphic creation facility. Manufacture/graphic creation facility 64 can utilize information relayed from the provider system 60 corresponding with the graphics image to create customized decals, direct application systems, mask systems, or other technical know how to facilitate final creation of the graphics image for disposition on a motor vehicle. Provider system 60 is also optionally connected with a third-party 62. Provider system 60 can optionally relay information to a third-party 62 for creation or disposition of the graphics image on a motor vehicle. For example, the provider system 60 can relay the created graphic image to a third party 62 such as a skilled artisan, paint shop, or the like which can directly apply in custom format the selected graphic image which has been created by the user.

According to one embodiment of the present invention, client 54 corresponds with an at home personal computer which utilizes software, computer program product, an Internet webpage, or the like to load the client interface and create a graphics image. The client 56 corresponds with a system at a motor vehicle vendor location, a publicly accessible system, or another computer readable medium which can be utilized to access the network. In the illustrated embodiment, client 54 and client 56 can be operably connected such that a user can begin creation of a graphics image at a publicly available computer or other system. The graphic image can then electronically relay the information via email, Internet service, or the like, and continue additional work at a home or business setting at a client 54.

A kiosk 58 is also provided. Kiosk 58 can comprise a customized machine, system, or apparatus which provides point of sale marketing in connection with a computer interface or touch screen-type implementation which facilitates both the sale and user creation of a graphics image utilizing the client interface. For example, the kiosk 58 can be positioned at a tradeshow, sporting event, or motor vehicle retail store. The kiosk can include graphic images on the physical housing of the kiosk 58, which comprise marketing or sales-type material. The kiosk 58 can be provided with a touch screen or other electronic interface which allows a user to access the client interface and begin creation of graphic images. Kiosk 58 can also be connected with a client 54 allowing for the user to transmit an unfinished graphics rendering for later completion.

According to one embodiment of the present invention, client 54, client 56, and client 58 are linked utilizing network 50. Network 50 is connected with server 52. Server 52 contains computer program product, computer readable medium, software, or other electronic media for populating client interface 10. As the user accesses network 50, the user is linked with a client interface such as client 54, 56, or kiosk 58. During creation of the graphics image, information can be relayed to the server 52 as needed to facilitate and finalize the graphics creation process. According to one embodiment of the present invention, individual pages, database information, and the like are contained on the server. According to another embodiment of the present invention, a customer order number can be generated at the completion of the graphics purchase phase. The customer order number corresponds with the particular graphic which has been created by the user. The graphic and/or graphic package can then be relayed to the provided for generation of decals, direct graphic rendering, mask systems, or the like, to facilitate creation of the graphics image.

As previously discussed, provider system 60 is linked to the client interface either through network 50 and/or directly to the server 52. Provider system 60 can be utilized to populate additional content for the client interface, to access customer orders, and graphics renderings, download purchase and billing related information, and provide additional functionality to facilitate proper operation of the client interface and to facilitate creation of the graphics renderings. According to one embodiment of the present invention, manufacture/graphic creation facility 64 has one or more different components which can facilitate creation of a graphics image. For example, according to one embodiment of the present invention, the manufacture/graphics creation facility includes a decal printer which can print the graphics images created by the user on to decals which can then be shipped to the user or directly applied to the motor vehicle as desired by the provider system. According to another embodiment, the manufacture/graphic creation facility corresponds with a facility in which a graphic can be directly applied to the motor vehicle. For example, the motor vehicle is brought to the manufacture/graphic creation facility. The motor vehicle can then be positioned, cleaned and otherwise prepared for the application of the graphics image. An automated system can then detect the position of the motor vehicle, and begin to apply the graphics image utilizing automated systems to one or more different locations on the motor vehicle.

The disposition of the graphic image can be facilitated by the electronic image created by a client 54, 56, or 58 over network 50 and in conjunction with server 52. Once the motor vehicle has had all desired graphics images deposited thereon, the motor vehicle can be shipped, returned, or picked up by the user having the customized graphics images deposited thereon. According to another embodiment of the present invention, the provider system is linked with a third-party 62. Third-party 62 can correspond with an independent manufacturing facility which is located closer to the user. Additionally, the third-party can correspond with partner or related systems which can facilitate either fine tuning, cut-path, or image outline renderings, or other necessary systems component for creation and/or disposition of the graphics image on the motor vehicle.

As will be appreciated by those skilled in the art, a variety of types and configurations of network systems can be provided for facilitating creation of a graphics image according to one embodiment of the present invention. For example, according to one embodiment of the present invention, the information is directly relayed from the kiosk to a manufacturing facility without the interposition of a network therebetween. According to another embodiment of the present invention, software is provided to a client. Subsequent to completion of a graphics image, the software is then directly mailed in hard copy to a provider or manufacture facility which then can create the graphics image as desired. According to another embodiment of the present invention, a client side printer is provided which allows for the creation of a graphics image directly at a point of sale, such as a tradeshow, motor vehicle vender, or the like.

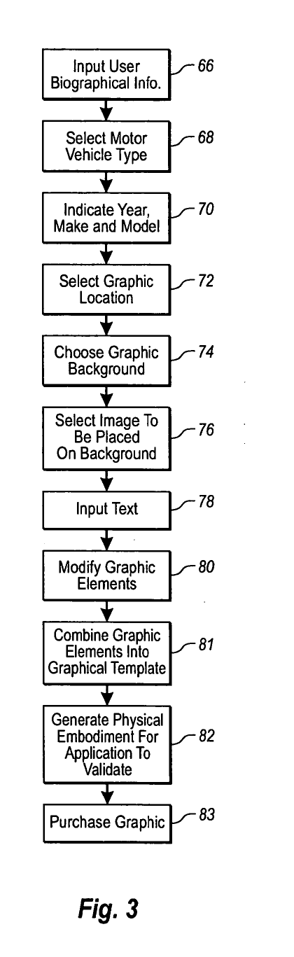

FIG. 3 is a flow diagram illustrating the creation of a graphics image at a client interface, according to one embodiment of the present invention. According to the illustrated embodiment, the method of creating graphics image or utilizing the client interface comprises inputting user biographical information at a step 66. By inputting user biographical information, a client identification number, or a client order number can be associated with a specific graphics image to be created. Subsequent to inputting the user biographical information, the user selects a motor vehicle type, such as a motorcycle, ATV, snowmobile, scooter, automobile, or the like, in step 68. Subsequent to selecting the motor vehicle type, the user indicates the year, make, and model of the motor vehicle in step 70. The user then selects a graphic location in a step 72. The graphic location corresponds with the part or position on the motor vehicle with which the graphic is to be deposited. Subsequent to selecting the graphic location, the user selects the graphic background to be associated with the graphic image in a step 74. Subsequent to the selection of the graphic background, the user selects an image to be placed on the background in a step 76. The user can then input text which will be included as part of a graphic image in a step 78. Subsequent to inputting text, the user can modify one or more graphic elements to create a final look and feel of the graphic in a step 80. The user can then select to have the graphic elements combined into a graphic template in step 81. Combining the graphic elements into a graphic template creates a final version of the graphic that can be placed on a physical embodiment such as a decal, sticker, mask, direct application, or the like. Subsequent to combining the graphic elements into a graphic template, a physical embodiment can be generated for application to a vehicle in step 82. The user can then purchase the graphic in a step 83.

As will be appreciated by those skilled in the art, a variety of methods and systems can be utilized for the creation of a graphics image. For example, according to one embodiment of the present invention, the components of the graphics image are created before indicating the type of motor vehicle and the year, make, and model of the motor vehicle. According to another embodiment, the look and overall feel of the graphic is created before a particular graphic location is selected. The user can subsequently modify the look and feel of the graphic to the particular location which the graphic is to be utilized. According to another embodiment of the present invention, the user can create the graphic image without inputting biographical user information. According to another embodiment of the present invention, purchasing of the graphic is conducted at the beginning of the system, rather than subsequent to creation of the graphic image. According to another embodiment, generating a physical embodiment is not included as part of the process. According to another embodiment, the graphic is purchased before generating the physical embodiment.

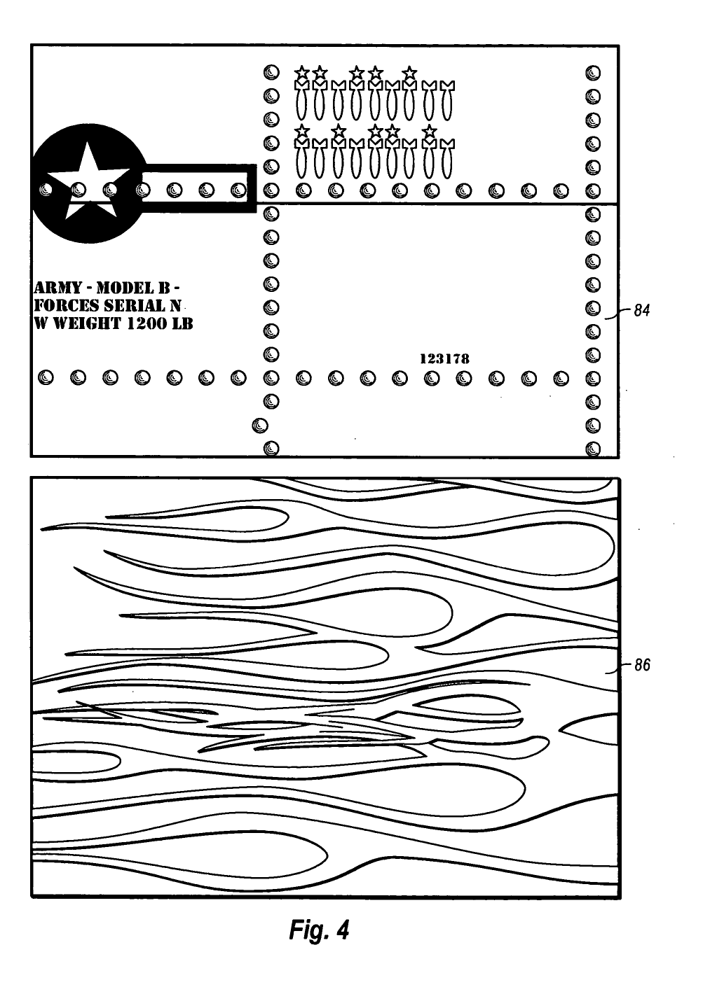

FIG. 4 is an illustrative view of exemplary backgrounds that can be used as part of a graphic image, according to one embodiment of the present invention. In the illustrated embodiment, a military graphic background 84 and a flame graphic background 86 are provided. Military graphic background 84 and flame graphic background 86 are exemplary embodiments of options that can be provided for a user in the creation of graphic element.

During the creation of a graphic image, the user can browse through potential graphic backgrounds which can be utilized as part of a graphic image. This can assist the imagination of the user and be helpful in the creation of the overall look and feel of the graphic image. Additionally, the graphic background can help facilitate the selection of a particular thematic element that the user would like to underlie the graphics components of one or more parts of the overall graphics package. For example, in the event that the user desires to have a military theme to the graphic image the user can utilize military graphic background 84.

According to one embodiment of the present invention, the graphic backgrounds, such as military graphic background 84 and flame graphic background 86, are sufficiently detailed and sufficiently large such that all or a portion of the image can be utilized in the creation of the graphic image. For example, in the event that the user desires to primarily utilize the star on the left hand portion of military graphic background 84, the left hand portion of the graphic can be utilized to provide the entire background for the graphic image.

A variety of types and configurations of background navigation options can be provided without departing from the scope and the spirit of the present invention. For example, according to one embodiment of the present invention, a plurality of thumbnails are provided on the graphic interface to provide a preview of the background and allow the user to preview images before a more detailed analysis of the background is required. According to another embodiment of the present invention, a title or other descriptive label is provided allowing the user to conceptualize different background images that can be available. For example, an “Old Iron Sides”-military logo can be provided to correspond with military background 84. According to another embodiment of the present invention, the user can scroll between screens to view alternative backgrounds. According to yet another embodiment of the present invention, a combination of one or more known navigation tools can be provided.

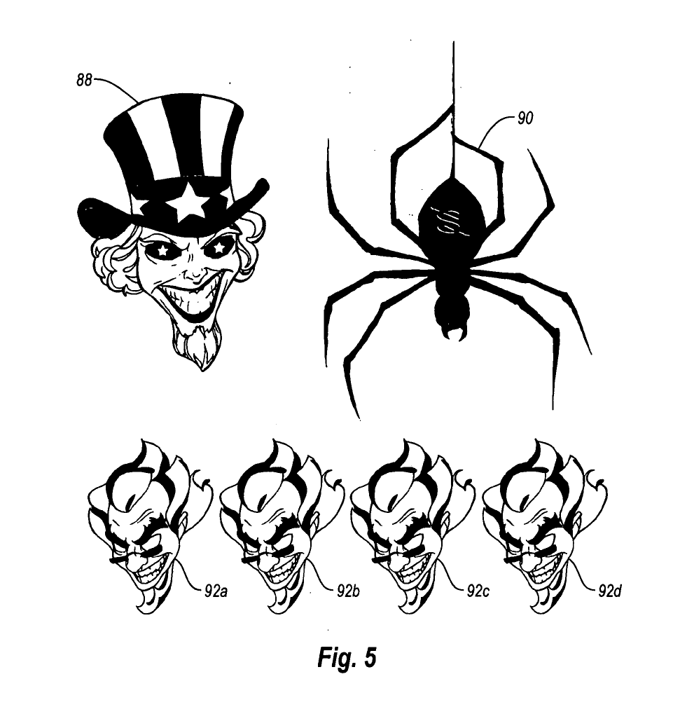

FIG. 5 is an illustrative view of different images that can be utilized independently, or in connection with a particular background to create a desired graphics image. In the illustrated embodiment, an Uncle Sam image 88, a black widow image 90, and laughing man images 92a-d are provided. Images 88, 90, and 92a-d are included merely as illustrative examples of images that can be provided. In the illustrated embodiment, a user can select one of images 80, 90, 92a-d, either alone or in combination with a background, to provide a desired graphic image. For example, in the event that an American flag-type background is utilized, a user may desire to couple the American flag background with Uncle Sam image 88. The combination of Uncle Sam image 88 coupled with the background of an American flag can create a patriotic theme, which may also have color patterns which correspond with the motor vehicle color to create a desired overall effect.

One or more of the provided images can have different color schemes which can be selected once a primary image is selected. For example, laughing man image 92a can have a blue coloration, laughing man image 92b can have a green coloration, 92c can have a substantial yellow coloration, and background image 92d can have a purple coloration. Thus, once the user identifies a particular image, a desired color pattern that may correspond with the color of the motor vehicle, or the background, can be selected to provide the overall desired effect. According to one embodiment of the present invention, each of the different color patterns are initially provided to the user illustrating the different color variations that can be selected. According to another embodiment of the present invention, once an initial image is selected, different variations of that image, including different color patterns, are illustrated to the user. According to another embodiment of the present invention, the user selects a color pattern and images available in that color pattern are provided to the user. According to yet another embodiment of the present invention, one or more images have different fields that can be modified by the user utilizing the graphics image tools to create customized color effects on one or more portions of the image.

As will be appreciated by those skilled in the art, the illustrated images are exemplary in nature only. A variety of types and configurations of images can be utilized without departing from the scope and spirit of the present invention. For example, according to one embodiment of the present invention, the images that are provided are selectably programmed to correspond with a particular background. For example, in the event that the user selects an American flag, the system first depicts to the user American flag-type symbols, such as Uncle Sam, Lady Liberty, an American soldier, or an eagle. The system can also be configured such that all options can be navigated in the event that the user rejects or is interested in viewing alternatives other than those initially provided by the system. According to another embodiment of the present invention, a field is provided which allows a user to submit their own background and/or graphics image other than the stock images provided by the system. According to another embodiment of the present invention, before submission of user selected images, the user must first sign a disclaimer that the image is not owned, protected, or otherwise in violation of a third-party's intellectual or other property rights.

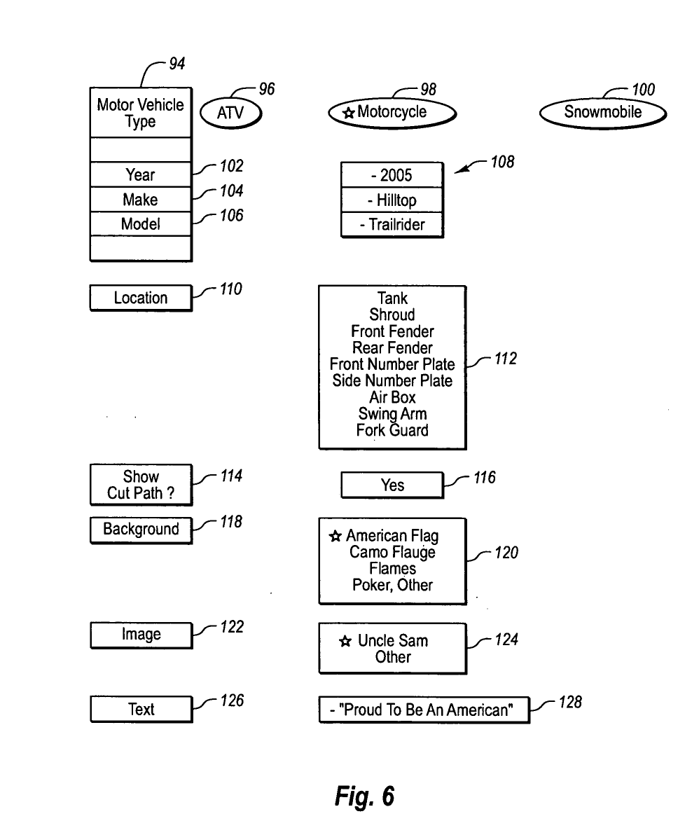

FIG. 6 illustrates, a system for generating a graphic image. In the illustrated embodiment, a plurality of fields are provided which correspond with selections that the user makes in creation of the graphics image. In the illustrated embodiment, a motor vehicle-type field 94, a graphic location field 110, a show cut-path field 114, a background 118, an image selection field 122, and a text input field 126 are provided. In the illustrated embodiment, motor vehicle type field 94 corresponds with an ATV selector 96, a motorcycle selector 98, and a snowmobile selector 100. ATV selector 96, motorcycle selector 98, and snowmobile selector 100 illustrate potential alternatives that can be selected by the user. In the illustrated embodiment, the user has selected motorcycle selector 98. Subsequent to selection of one of ATV selector 96, motorcycle selector 98, and snowmobile selector 100, a user can select the particular motor vehicle on which the graphic image is to be placed corresponding with motor vehicle year field 102, a motor vehicle make field 104, and a motor vehicle model field 106. In the illustrated embodiment, the user's selection and/or date are provided in the year, make, model selection field 108. For example, in the illustrated embodiment, the user has selected a hypothetical 2005 Hilltop Trailrider as the year, make, and model of the motorcycle on which the graphic is to be placed.

Once the particular motor vehicle has been selected, a graphic location listing 112 is provided in correspondence with a graphic location field 110. Graphic location listing 112 indicates the potential gamut of positions on the motor vehicle where graphic images can be positioned. For example, in the illustrated embodiment, for a 2005 Hilltop Trailrider motorcycle, the tank, shroud, front fender, rear fender, front plate, side number plate, air box, swing arm, and fork guard can all have graphic images positioned thereon. Graphic location listing 112 allows the user to select one or more of the potential locations for positioning a graphic image. Once the user has selected one or more of the locations, the system automatically facilitates creation of a graphics image for each and every selected location.

The user is then directed to select whether the cut-path of the particular location should or should not be depicted in correspondence with a show cut path field 114. A cut path selection 116 is provided which indicates whether the user desires to have the cut path depicted or not. In the illustrated embodiment, cut path selection 116 indicates that the user does in fact desire to have the cut path depicted. A background selection field 118 is also provided. Background selection field 118 facilitates browsing and selection of different backgrounds that can be used as part of the graphic image. For example, in the illustrated embodiment, available background listing 120 lists an American flag background, a camouflage background, flame background, a poker background, and also an other field which allows the user to view other alternatives that are available. In the illustrated embodiment, available background listing 120 indicates that the user has selected an American flag background.

Image selection field 122 allows the user to browse and select different images which can be positioned on the background corresponding with available background listing 120. Available image listing 124 facilitates viewing, navigation, and selection of different images that can be utilized as part of the graphics image. In the illustrated embodiment, available image listing 124 indicates that an Uncle Sam image has been selected. Text input field 126 allows a user to select or input text which is to be included as part of the graphic image. An image selected field 128 indicates text that has been inputted or stock text which can be utilized in connection with the graphics image. In the illustrated embodiment, “Proud to be an American” has been selected as the text to be utilized with the other components of the graphics image. Utilizing fields 94, 110, 114, 118, 122, and 126 and their corresponding selection indicators facilitates creation of graphics images in a straightforward and logical fashion. This allows the user to understand and select from the universe of available options in creating a unique and customized graphic image for one or more locations on the user's motor vehicle.

As will be appreciated by those skilled in the art, a variety of types and configurations of systems for facilitating selection of graphics can be utilized without departing from the scope and spirit of the present invention. For example, according to one embodiment of the present invention, separate pages are provided which can be browsed by the user to select motor vehicle, location, image component, and other aspects of the graphics image creation system. For example, a motor vehicle type page can be provided which allows the user to select the motor vehicle type, year, make and model, which is separate from other fields corresponding with the graphics image. According to another embodiment, a background page is provided which includes a number of thumbnails depicting miniaturized version of backgrounds and/or descriptive labels corresponding with different components of the graphic. According to another embodiment of the present invention the background, image, and text fields are populated such that preliminary options given to the user correspond with previous selections which have been made by the user. For example, in the event that the user selects an American flag background, American flag thematic images and text are provided to the user to facilitate the creative design process. According to another embodiment of the present invention, the system is configured to accept graphics images that can be uploaded from the user, such that the user's own customized and self-created images can be imported into the system, allowing the user to create graphics to be applied to the motor vehicle, including components that are not provided as part of the stock images or background inherently provided in the user interface.

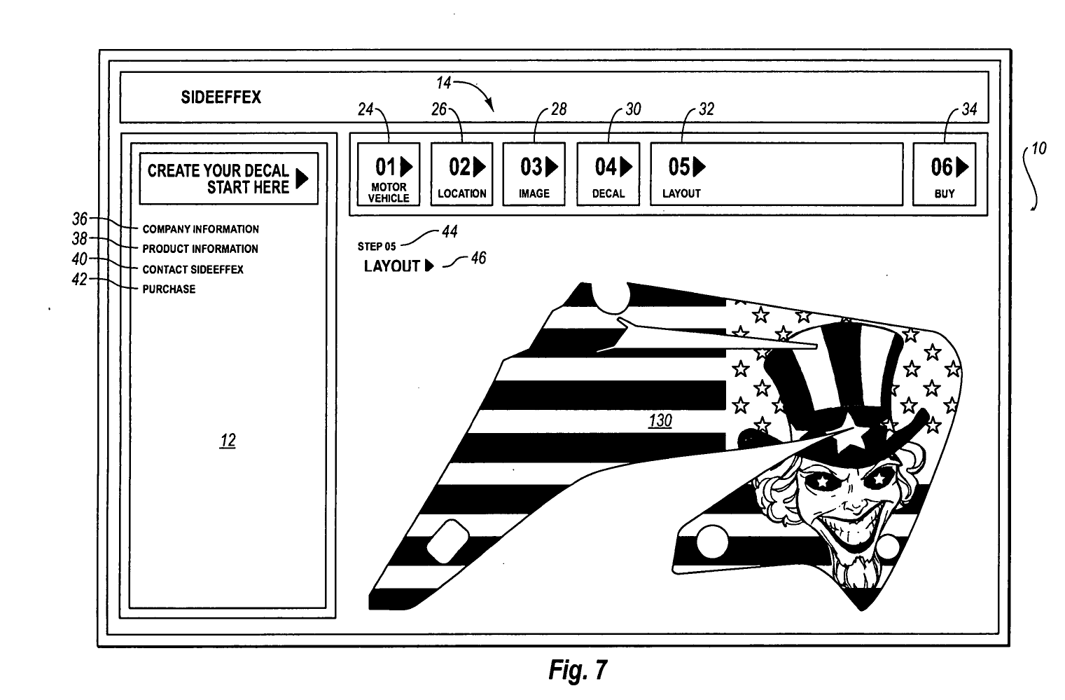

FIG. 7 illustrates client interface 10 in which step 05, or the layout phase of the graphics creation system corresponding with layout thumbnail 32, is being undertaken according to one embodiment of the present invention. In the illustrated embodiment, a graphic rendering 130 is depicted. Graphic rendering 130 illustrates a graphic image which has been created utilizing previously described steps in connection with client interface 10. For example, a particular motorcycle has previously been selected in a first step, a location of the decal has previously been selected (in this case, potentially the gas tank of a motorcycle), a background and foreground image have been previously selected, and a cut-path of the decal is illustrated. In the layout phase corresponding with layout thumbnail 32, the user can visualize the configuration of the image and background and how it is positioned on the cut-path or outline of the graphic image as it will appear on the motor vehicle. This allows the user to modify and/or change the elements of the graphics image to improve or otherwise change the look and feel of the graphics image. For example, the user can move the Uncle Sam image from the illustrated position on the right hand side of the cut-path to the left hand side of the cut-path. Alternatively, the user can add additional components, remove components, scale the background and/or image, add text, rotate, change the color scheme, or otherwise modify the configuration of the depicted graphic image.

As will be appreciated by those skilled in the art, a variety of types and configurations of tools can be utilized to facilitate the creation of a graphics image without departing from the scope and spirit of the present invention. For example, selection of the location of the image can be conducted once a preliminary layout has been selected. According to another embodiment of the present invention, selection of an application methodology such as a decal or direct graphics application can be selected before or after preparation of the layout of the image. According to another embodiment of the present invention, selection of the type of motor vehicle can be selected after a preliminary graphic image has been prepared.

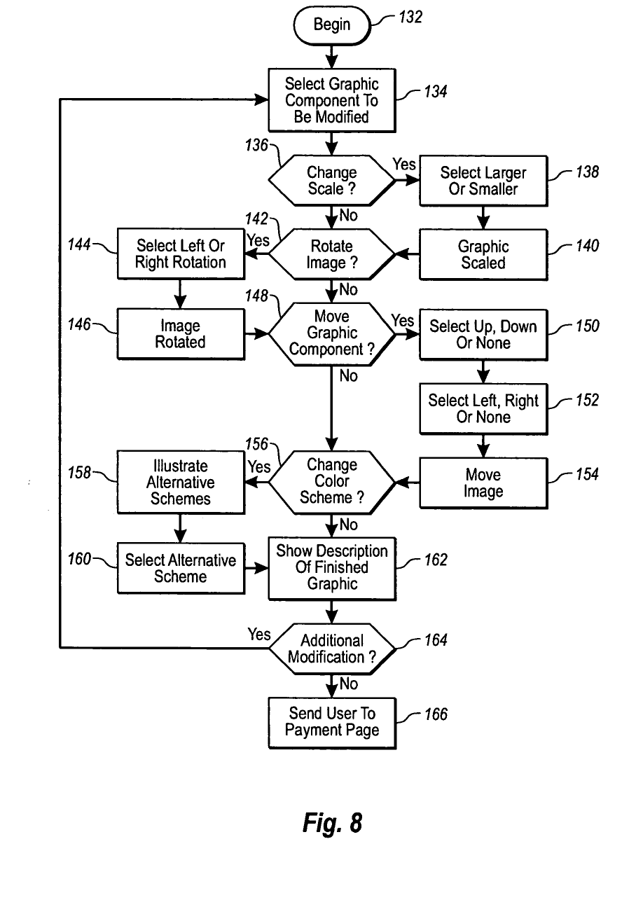

FIG. 8 is flow diagram depicting steps that can be utilized to modify the layout of a graphic subsequent to an initial rendition of a graphic image. In the illustrated embodiment, the user begins the selection process in step 132. The user selects a graphic component to be modified, such as the background, an image, or the like in step 134. After the user has selected a graphic component to be modified, the user can decide whether to change the scale of the graphic component in a decision step 136. In the event that user decides to change the scale of the component, the user selects whether to make the component larger or smaller in step 138. Once the user has selected whether to make the component larger or smaller, the graphic is scaled in step 140.

The user can select whether to rotate the image component in step 142. In the event that the user selects to rotate the image component, the user can select left or right rotation of the image in step 144. Once the user has selected left or right rotation of the image, the image is rotated in step 146. The user can then select whether to move the image component in step 148. In the event that the user selects to move the component, the user can select up, down, or no movement in step 150. The user can then select left, right, or no movement, in step 152. Once the user has selected up, down, left, or right movement of the image component; the image is moved in step 154. The user can then select whether to change the color scheme of the graphic component in step 156. In the event that the user does elect to change the color scheme, illustrative alternative color schemes are depicted in step 158. The user can then select an alternative color scheme in step 160. A depiction of the finished graphic is then depicted in step 162.

Once a depiction of the finished graphic is illustrated in step 162, the user can elect whether additional modification of the graphic is desired in step 164. In the event that additional modification of the graphic is desired, the user is returned to step 134 in which the user can select a graphic component to be modified. In the event that user does not desire additional modification of the graphic, the user is sent to the payment page in step 166. According to one embodiment of the present invention, in the event that the user does desire additional modification of the image, the user will select a separate and distinction component of the graphic image to be modified in step 134. For example, in the event that the initial modification was applied primarily to the background of the image, the additional modification or the subsequent graphic component to be modified may comprise the foreground image which placed on the background of the graphic image.

As will be appreciated those skilled in the art, a variety of types and configurations of systems for modifying the graphic component can be utilized without departing from scope and spirit of the present invention. For example, according to one embodiment of the present invention, selection of text can be added as a modification component of the layout selection system. According to another embodiment of the present invention, modification of the font, size, color, or other element of the text can be additionally included. According to another embodiment of the present invention, the scale, positioning, or other component of the text can be included as a modification alternative. As will be appreciated by those skilled in the art, the illustrated logic diagram is included for illustrative purposes only and should not be considered to be limiting in nature. For example, according to one embodiment of the present invention, modification of one or more components of a graphics image is conducted in a dynamic fashion in which, the user can utilize a cursor, mouse, tool bar, or other tool to dynamically change components of the system utilizing drag type capabilities, clicking rotational changes, color modification buttons, and other known graphics alteration systems and tools.

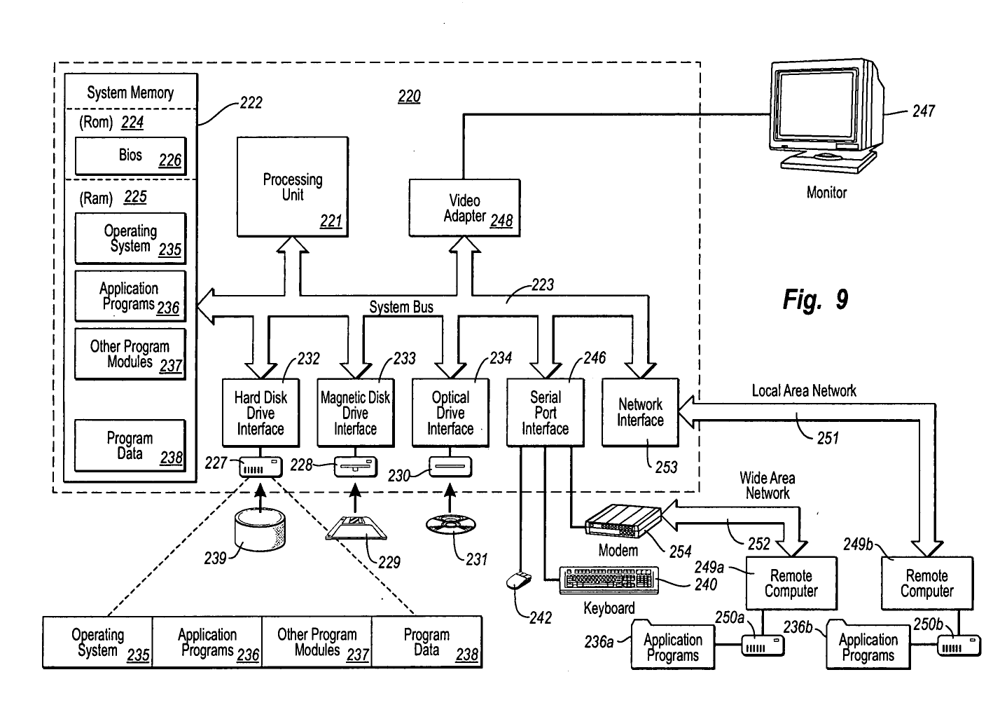

FIG. 9 illustrates a suitable operating environment for the principles of the present invention. FIG. 9 and the following discussion are intended to provide a brief, general description of a suitable computing environment in which the invention may be implemented. Although not required, the invention will be described in the general context of computer-executable instructions, such as program modules, being executed by computer systems. Generally, program modules include routines, programs, objects, components, data structures, and the like, which perform particular tasks or implement particular abstract data types. Computer-executable instructions, associated data structures, and program modules represent examples of the program code means for executing acts of the methods disclosed herein.

While FIG. 9 represents a suitable operating environment for the present invention, the principles of the present invention may be employed in any system that is capable of, with suitable modification if necessary, implementing the principles of the present invention. The environment illustrated in FIG. 9 is illustrative only and by no means represents even a small portion of the wide variety of environments in which the principles of the present invention may be implemented.

With reference to FIG. 9, an exemplary system for implementing the invention includes a general-purpose computing device in the form of a conventional computer 220, including a processing unit 221, a system memory 222, and a system bus 223 that couples various system components including the system memory 222 to the processing unit 221. The system bus 223 may be any of several types of bus structures including a memory bus or memory controller, a peripheral bus, and a local bus using any of a variety of bus architectures. The system memory includes read only memory (ROM) 224 and random access memory (RAM) 225. A basic input/output system (BIOS) 226, containing the basic routines that help transfer information between elements within the computer 220, such as during start-up, may be stored in ROM 224.

The computer 220 may also include a magnetic hard disk drive 227 for reading from and writing to a magnetic hard disk 239, a magnetic disc drive 228 for reading from or writing to a removable magnetic disk 229, and an optical disc drive 230 for reading from or writing to removable optical disc 231 such as a CD ROM or other optical media. The magnetic hard disk drive 227, magnetic disk drive 228, and optical disc drive 230 are connected to the system bus 223 by a hard disk drive interface 232, a magnetic disk drive-interface 233, and an optical drive interface 234, respectively. The drives and their associated computer-readable media provide nonvolatile storage of computer-executable instructions, data structures, program modules and other data for the computer 220. Although the exemplary environment described herein employs a magnetic hard disk 239, a removable magnetic disk 229 and a removable optical disc 231, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 239, magnetic disk 229, optical disc 231, ROM 324 or RAM 225, including an operating system 235, one or more application programs 236, other program modules 237, and program data 238. A user may enter commands and information into the computer 220 through keyboard 240, pointing device 242, or other input devices (not shown), such as a microphone, joy stick, game pad, satellite dish, scanner, or the like. These and other input devices are often connected to the processing unit 221 through a serial port interface 246 coupled to system bus 223. Alternatively, the input devices may be connected by other interfaces, such as a parallel port, a game port or a universal serial bus (USB). A monitor 247 or another display device is also connected to system bus 223 via an interface, such as video adapter 248. In addition to the monitor, personal computers typically include other peripheral output devices (not shown), such as speakers and printers.

The computer 220 may operate in a networked environment using logical connections to one or more remote computers, such as remote computers 249a and 249b. Remote computers 249a and 249b may each be another personal computer, a server, a router, a network PC, a peer device or other common network node, and typically include many or all of the elements described above relative to the computer 220, although only memory storage devices 250a and 250b and their associated application programs 236a and 236b have been illustrated in FIG. 9. The logical connections depicted in FIG. 9 include a local area network (LAN) 251 and a wide area network (WAN) 252 that are presented here by way of example and not limitation. Such networking environments are commonplace in office-wide or enterprise-wide computer networks, intranets and the Internet.

When used in a LAN networking environment, the computer 220 is connected to the local network 251 through a network interface or adapter 253. When used in a WAN networking environment, the computer 220 may include a modem 254, a wireless link, or other means for establishing communications over the wide area network 252, such as the Internet. The modem 254, which may be internal or external, is connected to the system bus 223 via the serial port interface 246. In a networked environment, program modules depicted relative to the computer 220, or portions thereof, may be stored in the remote memory storage device. It will be appreciated that the network connections shown are exemplary and other means of establishing communications over wide area network 252 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A client interface in a computerized environment in which an application having graphics images are provided to a user for the selection, modification, and creation of desired graphics images and generation of an application system for direct application of the graphics image on a motorized vehicle to provide an overall design to the motorized vehicle, the interface comprising:
a motor vehicle selection field allowing the user to identify the motor vehicle to which the graphic will be applied;
user navigatable graphics content having one or more user selectable variants configured for use with the motor vehicle that can be combined, modified, or selected to generate a graphics image;
graphics modification tools allowing the user to input instructions to modify one or more components of the graphics image; and
graphics image storage adapted to store the graphics image for generating a physical embodiment of the graphics image on the motor vehicle.

2. The interface of claim 1, wherein, the physical embodiment comprises a mask.

3. The interface of claim 1, wherein, the physical embodiment comprises automated direct application of paint to the motor vehicle.

4. The interface of claim 1, wherein the physical embodiment comprises a decal.

5. The interface of claim 1, wherein the physical embodiment is applied directly to the motor vehicle.

6. The interface of claim 1, wherein the physical embodiment is prepared for subsequent disposition on the motor vehicle.

7. The interface of claim 1, wherein the navigatable graphics comprise background images.

8. The interface of claim 7, wherein the navigatable graphics comprise foreground images.

9. The interface of claim 8, wherein the foreground images are positionable on the background images.

10. A computer program product for use in a computerized environment in which an application having populated graphics images are provided to a user for the selection, modification, and creation of desired graphics images and permitting direct application or generation of a decal, sticker, mask, or other application system to a motorized vehicle to provide an overall design to the motorized vehicle, comprising the following:
identifying a motor vehicle to which a graphic will be applied;
selecting one or more user selectable variants of graphics components from user navigatable graphics content, the user selectable variants configured for use with the identified motor vehicle, the user selectable variants configured to be combined, modified, or selected to generate a graphics image;
modifying at least one of the one or more graphics components to change the look and feel of the graphics; and
using the graphical template to generate a physical embodiment for application to the motor vehicle.

11. The computer program product of claim 10, wherein modifying at least one of the one or more graphics components comprises scaling the one or more graphics components.

12. The computer program product of claim 10, wherein modifying at least one of the one or more graphics components comprises rotating the one or more graphics components.

13. The computer program product of claim 10, wherein modifying at least one of the one or more graphics components comprises changing the color scheme of the one or more graphics components.

14. The computer program product of claim 10, wherein modifying at least one of the one or more graphics components comprises altering individual components of the one or more graphics components.

15. The computer program product of claim 10, wherein modifying at least one of the one or more graphics components comprises adding text to the one or more graphics components.

16. The computer program product of claim 10, wherein the physical embodiment comprises one or more of a decal, sticker, mask, direct application for disposition of the graphics image on the motor vehicle.

17. At a computer system, a method of generating a graphics image in a computerized environment in which an application having populated graphics images which are provided for the selection, modification, and creation of desired the graphics images and permitting direct application or generation of a decal, sticker, mask, or other application system to a motorized vehicle to provide an overall design to the motorized vehicle, the method comprising:
identifying a motor vehicle to which a graphic will be applied;
selecting one or more user selectable variants of graphics components from user navigatable graphics content, the user selectable variants configured for use with the identified motor vehicle, the user selectable variants configured to be combined, modified, or selected to generate a graphic template for the graphic;
combining the one or more graphics components into a graphical template; and
using the graphical template to generate a decal, sticker, mask, direct application, or other physical embodiment configured for application to the motor vehicle.

18. The method of claim 17, wherein the final shape of the graphic image is provided.

19. The method of claim 18, wherein the final shape of the graphic image comprises the cut path of decal to be positioned on a particular component of the motor vehicle.

20. The method of claim 17, wherein user can modify at least one of the one or more graphics components subsequent to a depiction of the final shape of the graphics image.

21. The method of claim 17, wherein a plurality of graphics images can be created for positioning on two or more different components of the motor vehicle.

22. The method of claim 17, wherein the motor vehicle can comprise a plurality of different motor vehicle types including one or more of an all terrain vehicle, a motorcycle, an auto vehicle, a snowmobile, a scooter, a personal watercraft, and a boat.

23. The method of claim 22, wherein the year, make, and model of the motor vehicle can be identified by the user.
